(19) United States
(12) Patent Application Publication
(10) Pub. No.: US 2009/0234789 A1
(43) Pub. Date: Sep. 17, 2009

(54) INFORMATION REPRODUCING APPARATUS, INFORMATION REPRODUCING METHOD, AND PROGRAM STORAGE MEDIUM

(75) Inventors: Kenji Odaka, Yokohama-shi (JP); Yoshiki Terashima, Kawasaki-shi (JP); Satoshi Ozaki, Kawasaki-shi (JP); Shirou Wakayama, Kawasaki-shi (JP); Keiichi Teramoto, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/393,485

(22) Filed: Feb. 26, 2009

(30) Foreign Application Priority Data
Mar. 11, 2008 (JP) 2008-061375

(51) Int. Cl. G06N 5/02

(52) U.S. Cl. 706/48

(57) ABSTRACT

An information reproducing apparatus includes: a content storage configured to store content which includes a plurality of resources and a utilization condition of the resources; a scenario storage configured to store a scenario which includes output rules each defining a way of combining one or more resources selected from the plurality of resources and a play list defining an order of reading the output rules; a reading out unit configured to read out the scenario and the content from the storages; a condition processing unit configured to perform processing for satisfying the utilization condition in the content; and an information combining unit configured to read the output rules in the order specified by the play list, combine the one or more resources according to respective one of the output rules and output combined resources for the respective one of the output rules.

### CROSS REFERENCE TO RELATED APPLICATIONS

This application is based upon and claims the benefit of priority from the prior Japanese Patent Applications No. 2008-61375, filed on Mar. 11, 2008; the entire contents of which are incorporated herein by reference.

### BACKGROUND OF THE INVENTION

1. Field of the Invention

The present invention relates to an information reproducing apparatus that reproduces content information whose right is possessed by one right holder based on a scenario created by another right holder, an information reproducing method, and a program storage medium.

2. Related Art

Some conventional information reproducing apparatuses have a mechanism for restricting the usage of content information possessed by a right holder when the content information is to be utilized or reproduced by another person, as disclosed in JP-A 2005-160041 (Kokai) and JP-A 2005-285089 (Kokai).

However, such restriction on usage is mainly for making content information be reproduced or displayed within an expected range and does not provide for adequate utilization of content information.

### SUMMARY OF THE INVENTION

According to an aspect of the present invention, there is provided with an information reproducing apparatus, comprising:

a content storage configured to store content which includes
a plurality of resources and
a utilization condition of the resources;

a scenario storage configured to store a scenario which includes

a plurality of output rules each defining a way of combining one or more resources selected from the plurality of resources and

a play list defining an order of reading the output rules;

a reading out unit configured to read out the scenario and the content from the scenario storage and the content storage;

a condition processing unit configured to perform processing for satisfying the utilization condition contained in the content; and

an information combining unit configured to read the output rules in the order specified by the play list, combine the one or more resources according to respective one of the output rules and output combined resources for the respective one of the output rules.

According to an aspect of the present invention, there is provided with an information reproducing method, comprising:

reading out content which includes a plurality of resources and a utilization condition of the resources from a content storage storing the content;

reading out a scenario which includes a plurality of output rules each defining a way of combining one or more resources selected from the plurality of resources and a play list defining an order of reading the output rules from a scenario storage storing the scenario;

performing processing for satisfying the utilization condition contained in the content; and

reading the output rules in the order specified by the play list, combining the one or more resources according to respective one of the output rules and output combined resources for the respective one of the output rules.

According to an aspect of the present invention, there is provided with a program storage medium storing a computer program for causing a computer to execute instructions to perform the steps of:

reading out content which includes a plurality of resources and a utilization condition of the resources from a content storage storing the content;

reading out a scenario which includes a plurality of output rules each defining a way of combining one or more resources selected from the plurality of resources and a play list defining an order of reading the output rules from a scenario storage storing the scenario;

performing processing for satisfying the utilization condition contained in the content; and

reading the output rules in the order specified by the play list, combining the one or more resources according to respective one of the output rules and output combined resources for the respective one of the output rules.

### BRIEF DESCRIPTION OF THE DRAWINGS

FIG. 1 is a block diagram generally showing the configuration of an information reproducing apparatus as an embodiment of the present invention;

FIG. 2 shows a description example of a utilization condition 123;

FIG. 3 shows an example of output rules 113;

FIG. 4 is a flow diagram generally illustrating the flow of processing by a content utilization checker 130;

FIG. 5 is a flow diagram showing a detailed procedure of processing at steps S14 and S15 of FIG. 4;

FIG. 6 shows a case where processing at step S15 of FIG. 5 succeeds;

FIG. 7 shows a case where processing at step S15 of FIG. 5 fails;

FIG. 8 shows an example of a detailed flow at step S24 of FIG. 5;

FIG. 9 shows an example of a check table;

FIG. 10 is a flow diagram showing the detailed procedure of processing at step S16 of FIG. 4;

FIG. 11 shows a case where processing at step S33 of FIG. 10 succeeds;

FIG. 12 shows a case where processing at step S33 of FIG. 10 fails; and

FIG. 13 shows an example of processing at step S34 of FIG. 10.

### DETAILED DESCRIPTION OF THE INVENTION

In the following, an embodiment of the present invention will be described with reference to drawings.

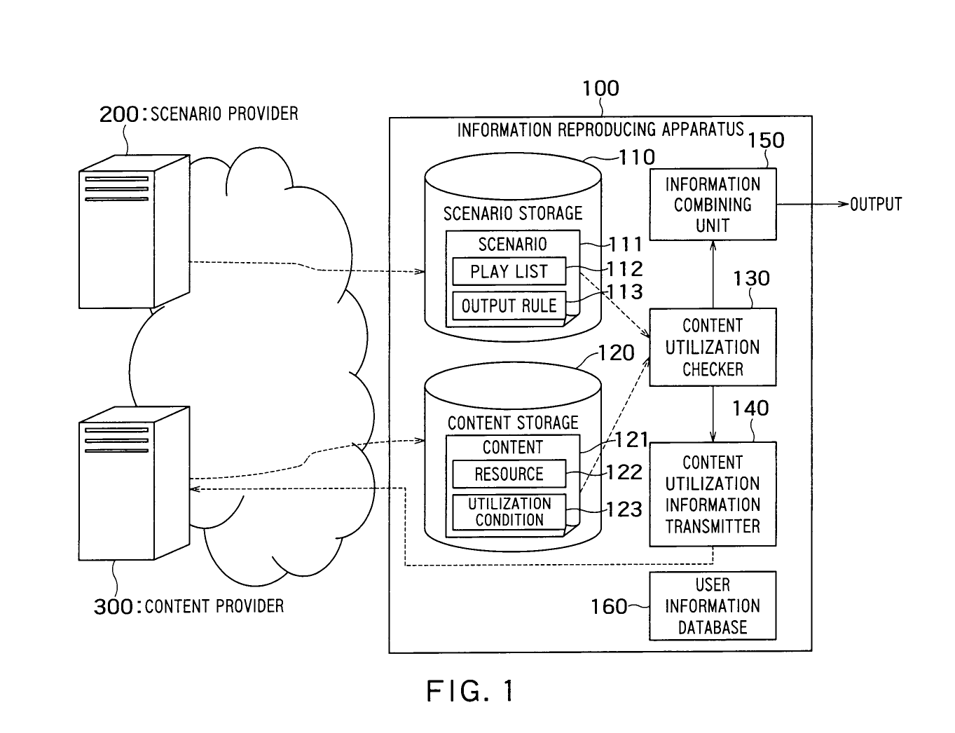

FIG. 1 is a block diagram generally showing the configuration of an information reproducing apparatus as an embodiment of the invention.

The information reproducing apparatus includes a scenario storage 110, a content storage 120, a content utilization checker 130, a content utilization information transmitter 140, an information combining unit 150, and a user information database 160.

The content storage 120 stores content 121 received from a content provider (a content provision server) 300 on the Web. The content 121 includes a plurality of resources 122 and a utilization condition 123 that defines one or more condition items required for utilizing the resources 122. The resources 122 may be image data, audio data, and text data (character data), for example.

The scenario storage 110 stores a scenario 111 received from a scenario provider (a scenario provision server) 200 on the Web. The scenario 111 includes a play list 112, a plurality of output rules 113, and detailed information such as the identifier of the content 121. The output rules 113 each define the way of combining one or more resources. The one or more resources to be combined form a resource set. The play list 112 specifies the order of reading the output rules (e.g., a way of reading).

The user information database (an information database) 160 stores user information for a user who utilizes the information reproducing apparatus 100. User information may be the user's personal information (e.g., the user's e-mail address, name, address), the user's utilization history (e.g., information on content so far used by the user, information on scenarios so far used by the user, etc.), or the like.

The content utilization checker (a reading out unit, a condition processing unit) 130 reads one scenario 111 from the scenario storage 110, retrieves a piece of content 121 from the content storage 120 based on the a content identifier contained in that scenario 111, and checks whether it is possible to satisfy condition items described in the utilization condition included in the content 121. Then, for a condition item which it determines can be satisfied, the content utilization checker 130 performs processing for satisfying the condition item.

As an example of processing for satisfying a condition item by the content utilization checker 130, when a condition item requires that a first resource 122 representing an image, sound, or text (characters) be reproduced or output, the content utilization checker 130 may modify the output rules 113 so that the first resource 122 is reproduced or output. The first resource 122 is a resource that is not included in any of resource sets (output rules) specified by a play list, for example. An output rule to be modified can be arbitrarily selected as long as the output rule permits modification. As another example of processing for satisfying a condition item by the content utilization checker 130, if another condition item requires that predetermined information (user information in the present example) be transmitted to a predetermined address, the content utilization checker 130 may read the user information from the user information database (the information database) 160 and order the content utilization information transmitter 140 to transmit the user information to the predetermined address.

The content utilization information transmitter (a data transmitting unit) 140 transmits information specified by the content utilization checker 130 to an address (e.g., a Uniform Resource Locator or URL) designated by the content utilization checker 130. In this embodiment, the address designated by the content utilization checker 130 is the address of the content provider 300, for instance.

The information combining unit (a reproduction processing unit) 150 reads out output rules 113 in an order of reading specified by the play list 112, combines one or more resources (i.e. a resource set) according to respective one of the output rules 113, and outputs the result of combining (i.e. combined resources) for the respective one of the output rules 113 on a display unit (not shown) by reproduction. In this way, the information combining unit 150 combines and reproduces each of resource sets in sequence.

In the following, the information reproducing apparatus of FIG. 1 will be described in greater detail.

The content 121 stored in the content storage 120 is described first.

As mentioned above, the content 121 includes a plurality of resources 122 and the utilization condition 123 that defines one or more condition items required for utilization of the resources 122.

Each of the resources 122 represents data itself, such as an image (still and moving images), audio, and characters (text). The resources 122 may also be a set of image (still and moving image) data, audio data, and character (text) data that are associated with each other by link information written in an XML or HTML file.

The utilization condition 123 defines one or more condition items required for utilizing the resources 122 as mentioned above. The utilization condition 123 is description information written in the same XML file as the resources 122 or a different XML file, being written according to the grammar of a markup language such as XML and HTML. When the utilization condition 123 is described in the same file as the resources 122, the utilization condition 123 is described as a part of the file.

For each condition item described in the utilization conditions 123, a requirement level (degree of enforcement) is set that indicates the extent to which the condition item should be satisfied. This embodiment employs two requirement levels of “mandatory” and “recommended”. When a condition item is “mandatory”, resources 122 cannot be utilized unless the condition item is satisfied. When a condition item is “recommended”, resources 122 can be utilized even if the condition item is not satisfied, but the condition item is satisfied to the extent possible. While this embodiment shows two requirement levels of “mandatory” and “recommended”, finer requirement levels may be set, e.g., three, four levels, and so on.

Examples of condition items include, as briefly mentioned above, insertion of resources 122 (data such as an image, audio, characters), replacement of resources 122, and deletion of resources 122. Further example is change of a portion or timing at which resources 122 are displayed.

As another example of condition items, desired information may be fed back to the content provider, as briefly mentioned above. Examples of information fed back to the content provider include:

(1) Meta data on the scenario 111 for utilizing the content 121 (e.g., the right holder name and/or the URL of a scenario provider, or scenario name)

(2) Personal information for the user of the information reproducing apparatus

(3) The user's usage history, such as the number of times or duration of utilizing the content 121

(4) History showing which condition item the content 121 satisfied to be reproduced or the like.

The two types of condition items shown above as examples can be described in an arbitrary combination. Such a combination of condition items also involves satisfaction of all of multiple condition items (“AND”) or one of multiple condition items (“OR”). Furthermore, the two types of condition item may also be described in a nested form.

This enables description of such condition items as:
Satisfy either one of logo insertion or sound replacement
Insert a picture and also insert a moving image
Satisfy either one of logo insertion or picture and moving image insertion,

allowing flexible condition items to be described.

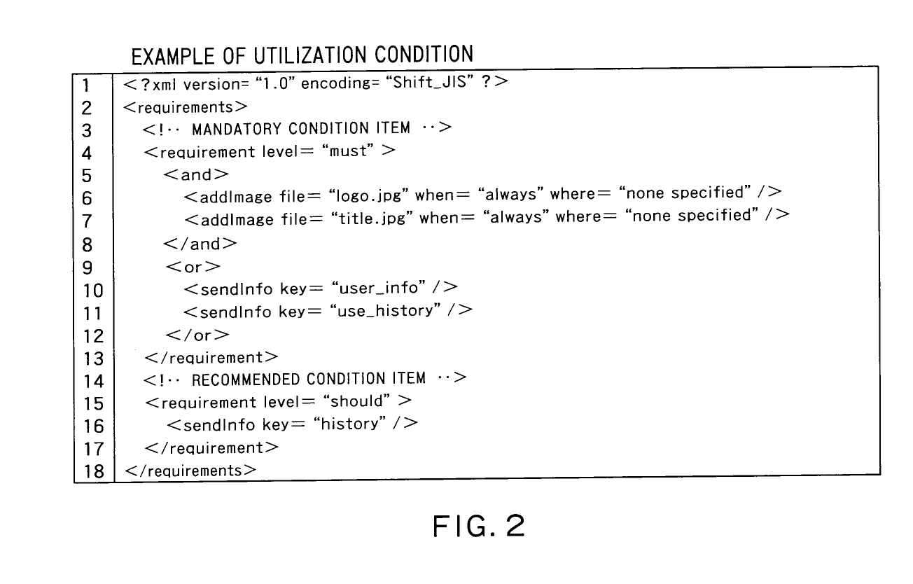

FIG. 2 shows a description example of the utilization condition 123.

The first line in FIG. 2 is XML declaration defined by XML specifications, showing that XML version is 1.0 and character code is Shift-JIS in this example. This is defined by XML specifications and is not description specific to a utilization condition. <Requirements> in the second line declares start of utilization condition description, and description between <requirements> in the second line and </requirements> in the last line is description about utilization conditions.

The description in the third and fourteenth lines that starts with “<!--” is a comment. Description of comment conforms to the XML grammar and is not description specific to a utilization condition.

Described between <requirement level=“must”> in the fourth line and </requirement> in the thirteenth line is description about a mandatory condition item. Described between <requirement level=“should”> in the fifteenth line and </requirement> in the seventeenth line is description about a recommended condition item. ‘Level=“ ”’ indicates a requirement level: when “must” is described in “ ”, it means “mandatory”, and when “should” is described in “ ”, it means “recommended”. In the case of “mandatory”, reproduction based on a play list is not carried out if the described condition item cannot be satisfied. In the case of “recommended”, reproduction takes place even if the described condition item cannot be satisfied. <And> in the fifth line and </and> in the eighth line indicate that both condition items written in the sixth and seventh lines that are surrounded by those lines need to be satisfied. <Or> in the ninth line and </or> in the twelfth line indicate that any one of condition items written in the tenth and eleventh lines surrounded by those lines need to be satisfied. In this example, because the “AND” and “OR” conditions are parallel, it is determined that the “mandatory” condition item is satisfied when all of the condition items in the sixth and seventh lines and any one of the condition items in the tenth and eleventh lines are satisfied.

The condition items of the sixth, seventh, tenth, eleventh, and sixteenth lines will be specifically described. The condition items in the sixth and seventh lines both request that an image be displayed all the time at any position. <AddImage> is an instruction requesting display of an image, “file” represents the file name of an image to be displayed, “when” represents the duration or timing of image display (“always” means the image should be displayed all the time), and “where” represents the position or space of display on a screen (“none specified” means an arbitrary position). While the duration of image display shown here is “always” (for the entire reproduction time of a play list), the present invention is not limited thereto and other duration may be specified, e.g., half the entire reproduction time or a specific amount of time represented by a numerical value. Also, the display position on the screen may be specified as a specific position instead of an arbitrary position. The value specified by “when” corresponds to a first time, for example, and the value specified by “where” corresponds to a first position, for example. The file name specified by “file” corresponds to a first resource, for example.

The condition items in the tenth, eleventh, and sixteenth lines request transmission of information. <SendInfo> is an instruction requesting transmission of information, and “key” specifies the type of information for transmission. “User_info” is the user's personal information (e.g., the user's e-mail address, name, and address), and “user_history” is the user's usage history (e.g., information on content or resources so far used by the user, and information on scenarios so far used by the user). The user's personal information and usage history are examples of user information.

The scenario 111 stored in the scenario storage 110 is described next.

The scenario 111 includes a plurality of output rules 113 each that define how to combine one or more resources (a resource set), the play list 112 specifying the order of reading out the output rules 113, and detailed information such as content identifiers.

The play list 112 is described in a markup language such as XML, and may be divided into another file such as by linking when the file size of the play list 112 has become large. The detailed information contained in the play list 112 describes:

(1) Creator information on the scenario provider, a delivery source URL, and metadata on the scenario provider

(2) Content name, delivery source URL, and content provider information as identification information of content 121 to be utilized.

The output rules 113 include description that defines the way of converting and combining one or more resources (i.e., a resource set). In other words, the output rules 113 describe how resources (images, moving images, music, characters (text) and so forth) should be combined and displayed. More specifically, the output rules 113 designate a position of display on the screen, timing of display, and/or duration of display for resources to be displayed on the screen, such as images, moving images, and text. For an audio resource or an audio resource for a moving image, the output rules 113 specify timing of reproduction start and end, length and/or sound volume of reproduction, and the amount of change in sound or timing of such change. The output rules 113 include description of the identifier (file name, URL, or ID) of one or more resources 112 to be utilized and description of the way of reproducing (or combining) those resources 122. The output rules 113 are described in a description language such as XML, and a plurality of output rules 113 may be present in one scenario as a file.

In the output rules 113, resource embedding information (resource addition information) for permitting additional embedding (additional reproduction) of resources may also be described. This is a significant feature of the present embodiment. With this feature, when a condition item “add a certain resource” is included in the utilization condition 123, the output rules 113 can be modified so that the resource is added at a position specified by such resource embedding information.

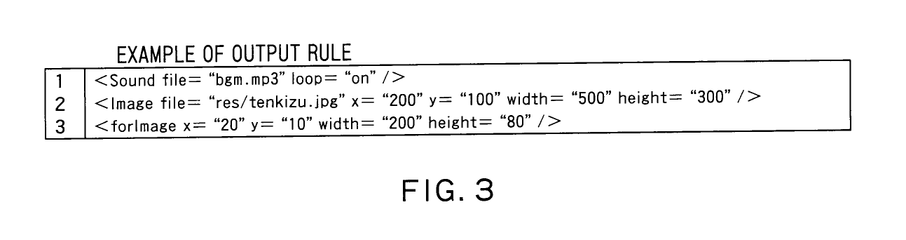

FIG. 3 shows an example of the output rules 113.

The first line represents an instruction for reproducing the resource in an audio file “bgm.mp3” all the time, and the second line represents an instruction for displaying the resource in an image file “res/tenkizu.jpg” at a specified position. The third line represents an instruction for allocating a space for embedding an image as resource embedding information. To be specific, this instruction indicates that an arbitrary resource can be embedded in a rectangular area with upper left coordinates of (20, 10), a horizontal width of 200, and a vertical length of 80. Thus, resource embedding information sets an area in which modification can be made through processing by the information combining unit 150. The duration for which an embedded image can be displayed is not particularly limited here and it is assumed that the image can be displayed all the time during reproduction corresponding to the output rule 113 in question. In resource embedding information, limitation on a duration for which an image can be displayed may be described.

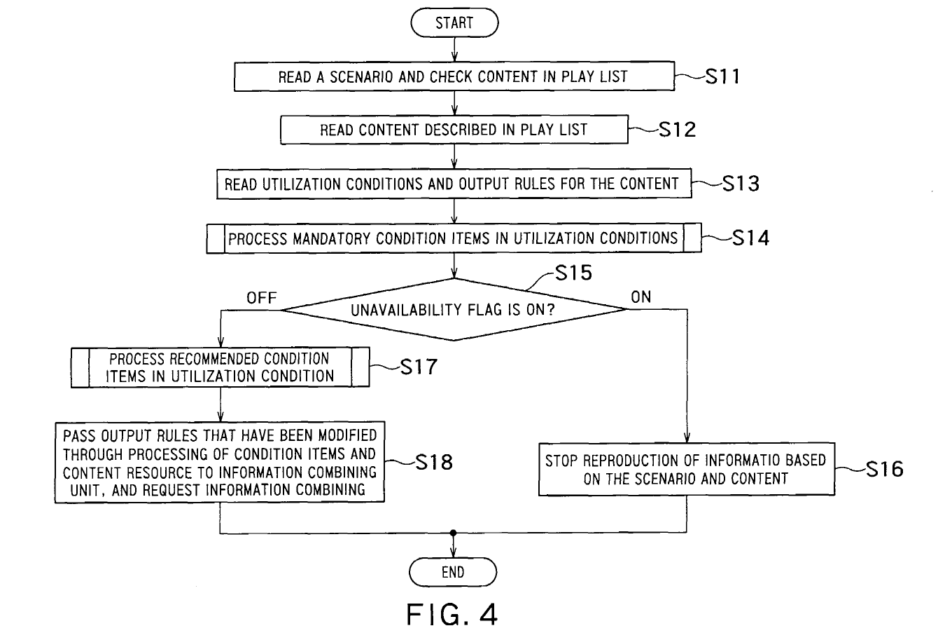

Now, details of processing performed by the content utilization checker 130 will be described using FIGS. 4 to 13.

FIG. 4 is a flow diagram generally illustrating the flow of processing by the content utilization checker 130.

The content utilization checker 130 reads a scenario 111 from the scenario storage 110 (S11), and reads a piece of content 121 from the content storage 120 based on a content name (a content identifier) contained in the play list 112 for the scenario 111 (S12).

The content utilization checker 130 analyzes the utilization conditions 123 of the content 121 read out and output rules 113 contained in the scenario 111 (S13), detects a mandatory condition item described in the utilization conditions 123, and performs processing for satisfying the mandatory condition item detected (S14). Details of step S14 will be described later.

The result of processing at step S14 is returned as an unavailability flag. If the unavailability flag is ON, that is, the mandatory condition item is not satisfied (ON at S15), reproduction of information based on the scenario 111 and content 121 is stopped (S16).

On the other hand, if the unavailability flag is OFF, that is, the mandatory condition item is satisfied (OFF at S15), the flow proceeds to step S17, where processing for satisfying a recommended condition item in the utilization conditions is performed. Details of step S17 will be described below.

Whether the recommended condition item is satisfied or not, at the following step S18, the resources 122 for the content 121, the output rules 113 (which may have been modified through processing for satisfying the mandatory and recommended condition items), and the play list 112 are passed to the information combining unit 150, which is requested to combine (or reproduce) pieces of information.

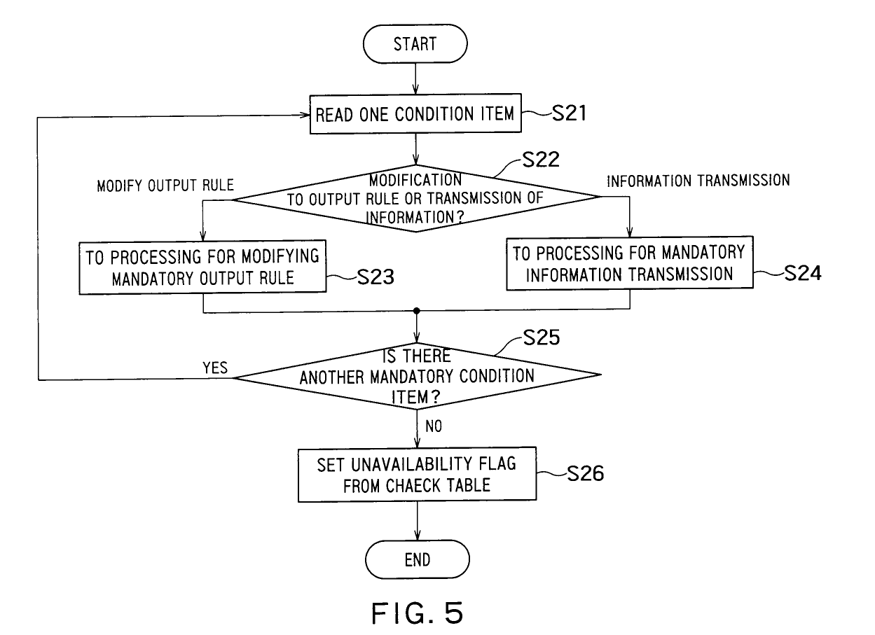

FIG. 5 is a flow diagram showing a detailed procedure of processing at steps S14 (processing on mandatory condition items in the utilization condition) and S15 of FIG. 4.

First, one condition item is read from the description of the utilization condition 123 (S21).

The contents of the condition item is checked (S22), and depending on the contents, the flow branches to either step S23 or S24.

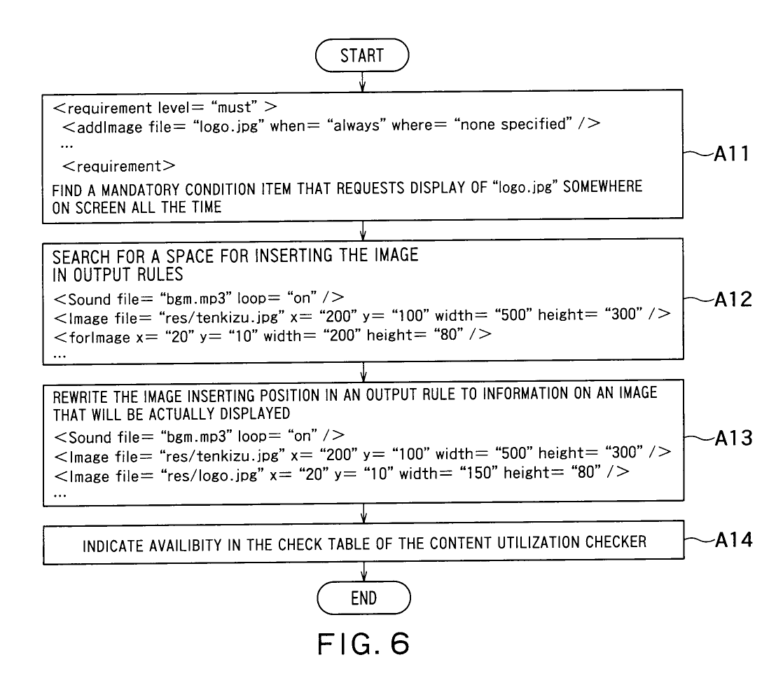

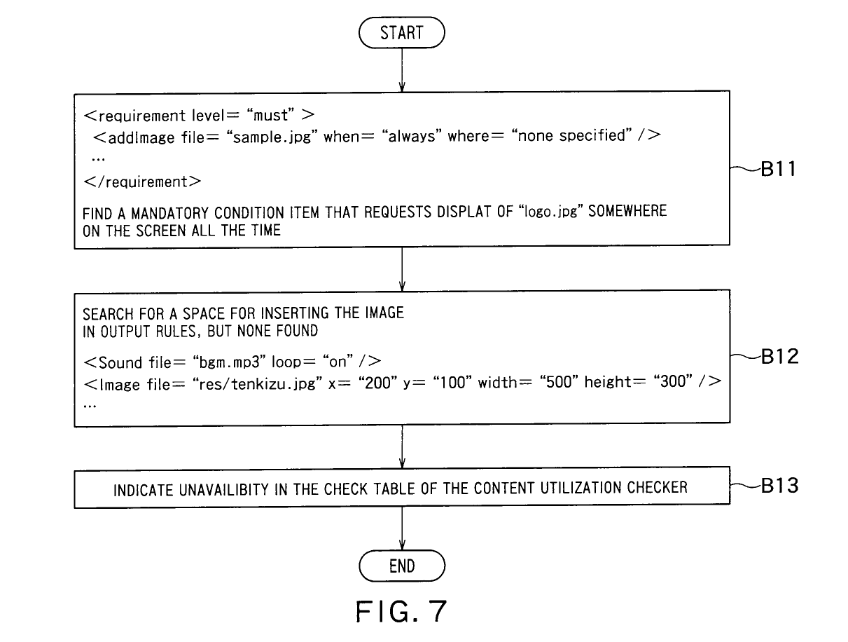

If the condition item is for modifying an output rule 113 (the way of resource utilization) (“modify output rule” at S22), processing for modifying the output rule 113 is performed (S23). An output rule 113 to be modified can be arbitrarily selected as long as the output rule 113 permits modification. FIGS. 6 and 7 show details of processing at this step as examples. FIG. 6 shows a case where processing for modifying an output rule succeeds, and FIG. 7 shows a case where such processing fails.

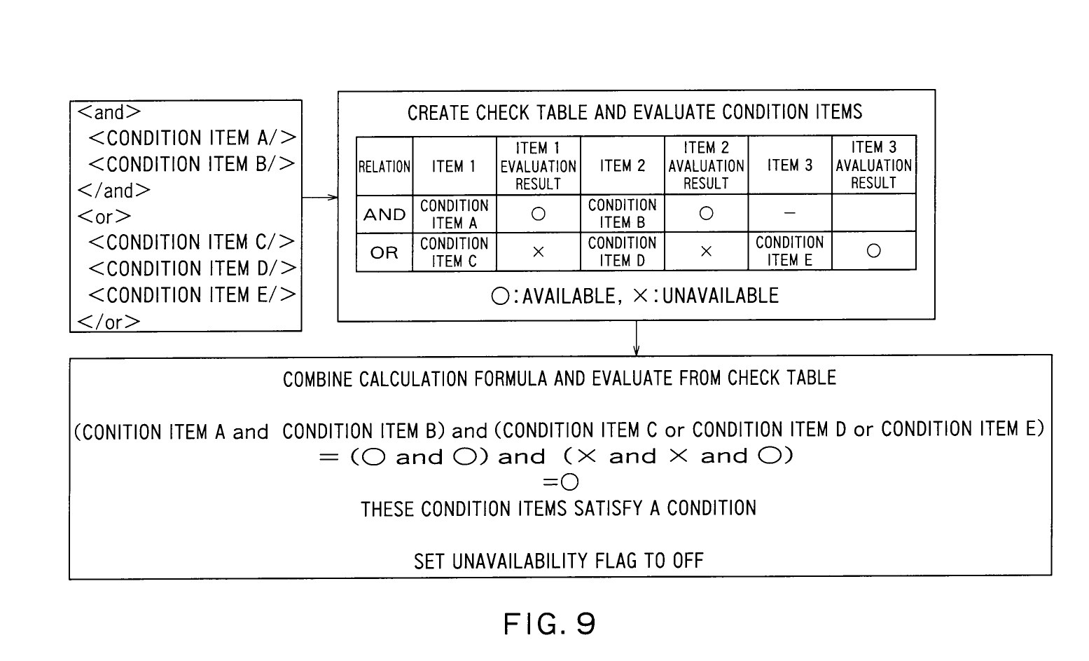

In FIG. 6, if the content utilization checker 130 finds a mandatory condition item that requests modification to an output rule 113 (e.g., display of “logo.jpg” on some position on a screen (where=“nonespecified”) all the time (when=“always”)) (A11), it searches for resource embedding information from the output rules 113 (A12), and rewrites the resource embedding information found to information on a resource that is to be actually embedded (A13). When it has rewritten information on the embedded resource for all the output rules 113, it writes a value indicating success of processing (e.g., ◯) in a check table (see FIG. 9 discussed below) (A14).

On the other hand, in FIG. 7, if the content utilization checker 130 finds a mandatory condition item that requests modification to an output rule 113 (e.g., display of “logo.jpg” at some position on the screen (where=“none specified”) all the time (when=“always”)) (B11), it searches for resource embedding information from the output rules 113 (B12). Because resource embedding information is not found in at least one output rule 113, it determines that the condition item cannot be satisfied and writes a value indicating failure of processing (e.g.,“×”) in the check table (B13).

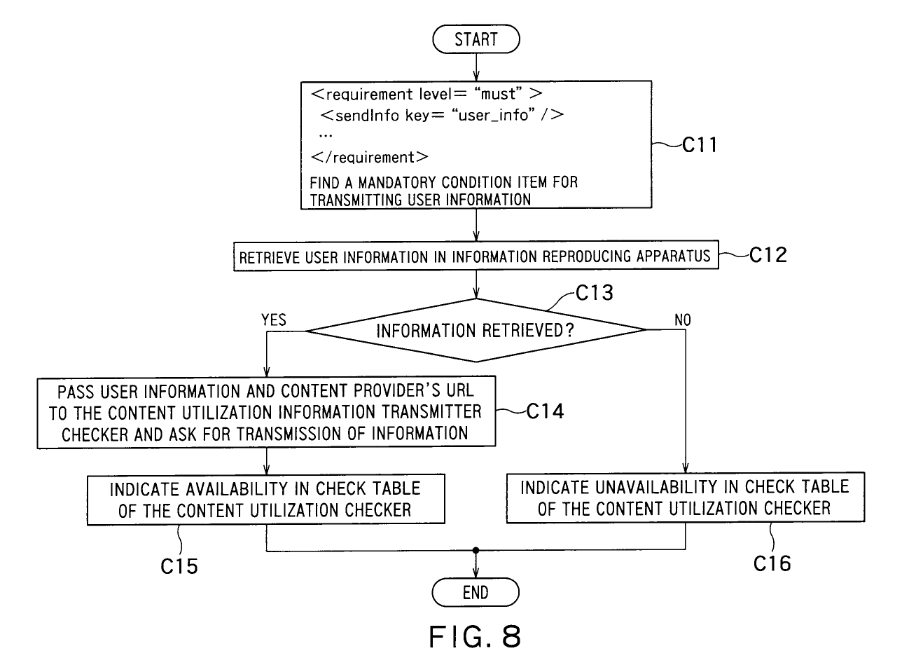

In FIG. 5, if the condition item read from the description of the utilization conditions 123 requests transmission of a particular type of information to the content provider (“information transmission” at S22), the content utilization information transmitter 140 is asked for transmission of the information (S24). A detailed flow of this processing is shown in FIG. 8. In FIG. 8, if the content utilization checker 130 finds a mandatory condition item for transmission of a particular type of information (user information here) (C11), it attempts retrieval of user information from the user information database (C12). If it successfully retrieves the user information, it passes the user information and the URL of the content provider contained in the content 121 to the content utilization information transmitter 140 so as to ask the content utilization information transmitter 140 to transmit the information to the content provider 300 (S14). The content utilization checker 130 then writes a value indicating success of processing to the check table (C15). However, if it could not retrieve the user information, the content utilization checker 130 determines that the condition item cannot be satisfied and writes a value indicating failure of processing in the check table (C16).

Here, determination of whether user information can be retrieved or not at step S12 may be made as follows, for example. Instruction data showing whether the user permits transmission of user information is received from the user. Retrieval of user information is determined to be possible if the instruction data indicates permission, and impossible if the instruction data indicates non-permission. Alternatively, reference may be made to information that shows whether transmission of user information is permitted or not by accessing a storage area or data storage specified in advance, and retrieval of user information is determined to be possible if the information indicates permission, and impossible if the information indicates non-permission.

When step S23 or S24 of FIG. 5 is completed, it is determined whether there is another mandatory condition item (S25), and if there is one (YES at S25), the flow returns to step S21. Processing at steps S21 through S25 is repeated for all mandatory condition items.

When processing is completed for all mandatory condition items (“NO” at S25), the check table to which recording was made at steps S23 and S24 is used to set the unavailability flag to OFF or ON (S26). An example of the check table is shown in FIG. 9. The check table contains relations between mandatory condition items (“AND” and “OR”) and the result of evaluating mandatory condition items (in the present example, “◯” for being satisfied and “×” for not being satisfied). A logical operation is performed based on the check table, and if a condition is satisfied as a whole as a result of the mandatory condition items (i.e., when condition items connected by “AND” are all satisfied (◯) and at least one of condition items connected by “OR” is satisfied (◯)), the unavailability flag is set to OFF, and if the mandatory condition is not satisfied, the unavailability flag is set to ON.

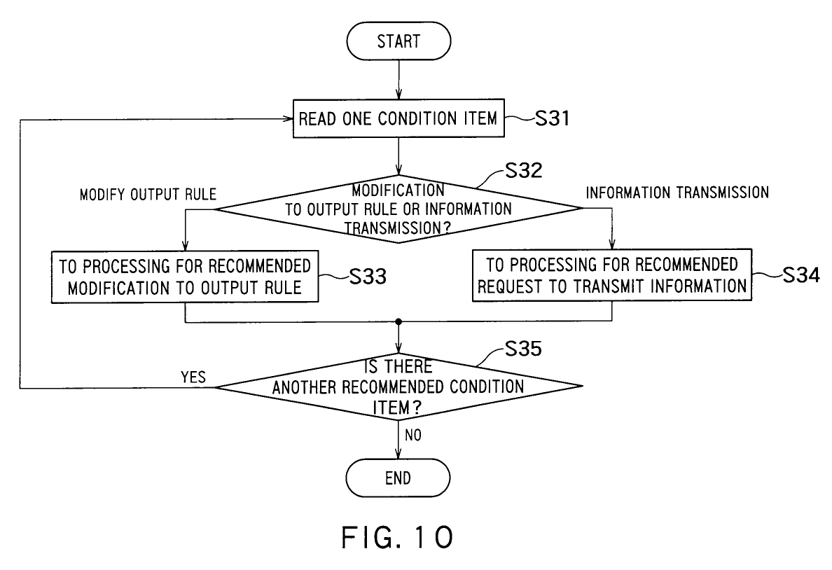

FIG. 10 is a flow diagram showing a detailed procedure of processing at step S17 of FIG. 4 (processing for a recommended condition item in the utilization condition).

For a recommended condition item, determination of whether processing succeeds is not performed because success or failure of processing is not examined. Therefore, when compared to the flowchart of FIG. 5 (the procedure of processing a mandatory condition item), the flow of FIG. 4 is different in that it does not involve determination of whether output is possible or not using the check table. It is otherwise similar to the flowchart of FIG. 5. Steps S31 to S35 of FIG. 10 correspond to steps S21 to S25 of FIG. 5, respectively.

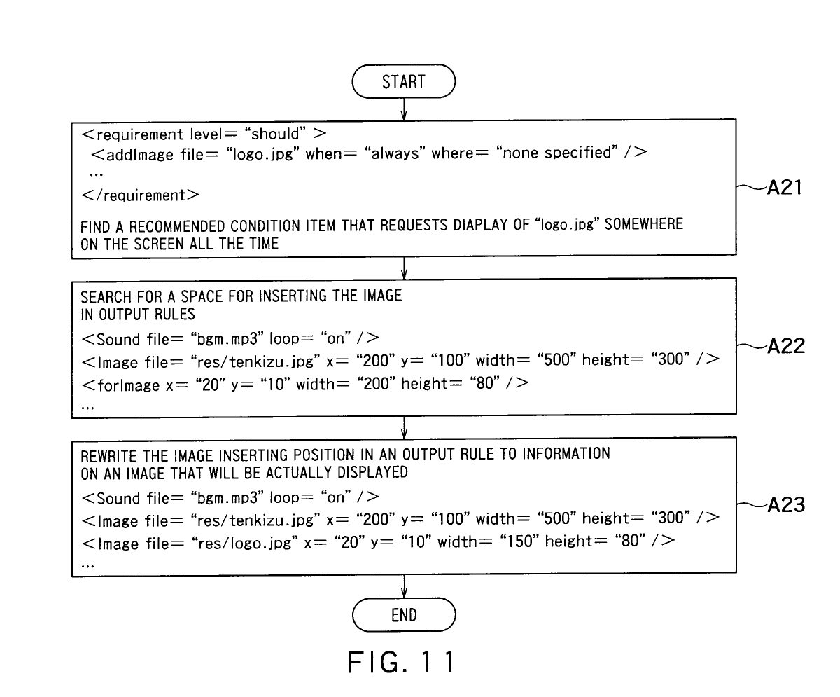

A case of processing being successful at step S33 of FIG. 10 (processing for modifying an output rule for a recommended condition item) is described in FIG. 11. Steps A21 to S23 are similar to steps A11 to A13 of FIG. 6, but processing corresponding to step S14 does not exist because determination using the check table is not performed.

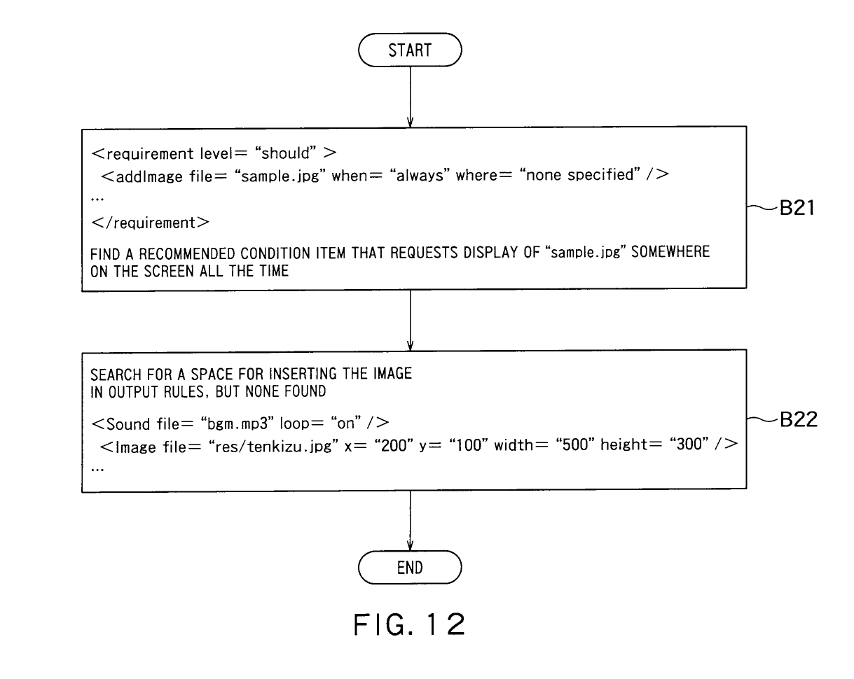

Also, a case of processing failing at step S33 of FIG. 10 is shown in FIG. 12. Steps B21 to S22 are similar to steps B11 and B12 of FIG. 7, but processing corresponding to step B13 does not exist because determination using the check table is not performed.

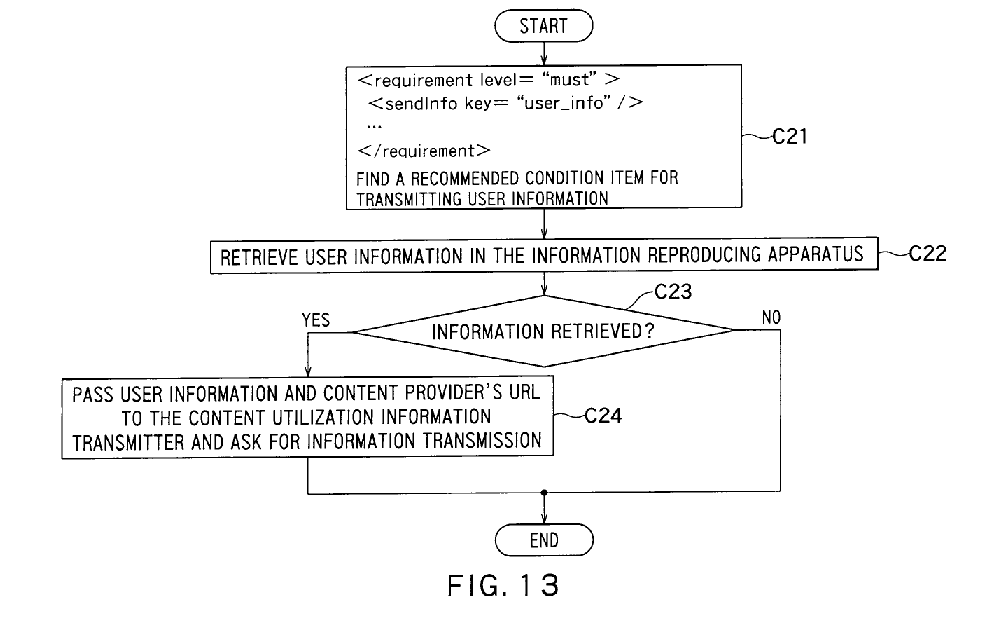

Also, a case of processing at step S34 (processing for transmitting user information for a recommended condition item) is shown in FIG. 13. Steps C21 to S24 are similar to steps C11 to C14 of the flowchart for a mandatory condition item (FIG. 8), but processing corresponding to steps C15 and C16 does not exist because determination using the check table is not performed.

The information combining unit 150 will be now described. The information combining unit 150 reads output rules 113 from the content utilization checker 130 in an order of reading specified in a play list and receives one or more resources 122 which are utilized in the output rules 113. The information combining unit 150 then combines the one or more resources 122 according to the output rules 113 to generate reproduction data and outputs the reproduction data on a display device not shown.

The content utilization information transmitter 150 is described next.

The content utilization information transmitter 150 receives the URL of the content provider 300 and information for transmission (e.g., user information) from the content utilization checker 130, and transmits the information to the content provider 300.

As described above, according to the present embodiment, it is possible to protect the right of the content provider 300 by modifying the output rules 113 of the scenario 111 in accordance with the utilization condition 123 of the content 121. In addition, with transmission of information owned by the information reproducing apparatus 100 to the content provider 300 according to the utilization condition 123 of the content 121, the content provider 300 can obtain desired information from a user who utilizes content.

The information reproducing apparatus of this embodiment may also be realized using a general-purpose computer device as basic hardware. That is, the content utilization checker 130, the content utilization information transmitter 140 and the information combining unit 150 can be realized by causing a processor mounted in the above described computer device to execute a program. In this case, the information reproducing apparatus may be realized by installing the above described program in the computer device beforehand or may be realized by storing the program in a storage medium such as a CD-ROM or distributing the above described program over a network and installing this program in the computer device as appropriate. Furthermore, the scenario storage 110 and the content storage 120 may also be realized using a memory device or hard disk incorporated in or externally added to the above described computer device or a storage medium such as CD-R, CD-RW, DVD-RAM, DVD-R as appropriate.

What is claimed is:

1. An information reproducing apparatus, comprising:
a content storage configured to store content which includes
a plurality of resources and
a utilization condition of the resources;
a scenario storage configured to store a scenario which includes
a plurality of output rules each defining a way of combining one or more resources selected from the plurality of resources and
a play list defining an order of reading the output rules;
a reading out unit configured to read out the scenario and the content from the scenario storage and the content storage;
a condition processing unit configured to perform processing for satisfying the utilization condition contained in the content; and
an information combining unit configured to read the output rules in the order specified by the play list, combine the one or more resources according to respective one of the output rules and output combined resources for the respective one of the output rules.

2. The apparatus according to claim 1, wherein
the utilization condition includes a plurality of condition items,
for each of the condition items, a requirement level selected from a plurality of requirement levels is set, and
the information combining unit does not perform processing when the condition item for which a highest requirement level among the condition items is set cannot be satisfied.

3. The apparatus according to claim 1, wherein
the utilization condition requires that a first resource which is different from the resources utilized in the output rules is additionally combined, and
the condition processing unit modifies at least any one of the output rules so that the first resource is additionally combined.

4. The apparatus according to claim 3, wherein
the utilization condition requires that the first resource continues to be outputted for a first duration, and
the condition processing unit modifies at least any one of the output rules so that the first resource continues to be outputted for the first duration.

5. The apparatus according to claim 3, wherein
the condition processing unit identifies an output rule that has resource addition information for permitting addition of the first resource among the output rules, as the output rule to be modified.

6. The apparatus according to claim 5, wherein
the utilization condition requires that the first resource is output at a first position on a screen, and
the condition processing unit modifies at least any one of the output rules so that the first resource is output at the first position on the screen.

7. The apparatus according to claim 6, wherein
the condition processing unit further identifies an output rule that has the resource addition information for permitting output of the first resource at the first position among the output rules, as the output rule to be modified.

8. The apparatus according to claim 1, further comprising:
an information database configured to store information; and
a data transmitting unit configured to transmit data, wherein
the utilization condition requires to transmit the information in the information database to a predetermined address, and
the condition processing unit reads out the information from the information database and transmits the read out information to the predetermined address using the data transmitting unit according to the utilization condition.

9. The apparatus according to claim 8, wherein
the condition processing unit determines whether the utilization condition can be satisfied based on instruction data inputted from a user indicating whether transmission of the information can be permitted or not.

10. The apparatus according to claim 8, wherein
the condition processing unit determines whether the utilization condition can be satisfied by reading out data indicating whether transmission of the predetermined information is permitted or not from a data storage storing the data.

11. An information reproducing method, comprising:
reading out content which includes a plurality of resources and a utilization condition of the resources from a content storage storing the content;
reading out a scenario which includes a plurality of output rules each defining a way of combining one or more resources selected from the plurality of resources and a play list defining an order of reading the output rules from a scenario storage storing the scenario;
performing processing for satisfying the utilization condition contained in the content; and
reading the output rules in the order specified by the play list, combining the one or more resources according to respective one of the output rules and output combined resources for the respective one of the output rules.

12. A program storage medium storing a computer program for causing a computer to execute instructions to perform the steps of:
reading out content which includes a plurality of resources and a utilization condition of the resources from a content storage storing the content;
reading out a scenario which includes a plurality of output rules each defining a way of combining one or more resources selected from the plurality of resources and a play list defining an order of reading the output rules from a scenario storage storing the scenario;
performing processing for satisfying the utilization condition contained in the content; and
reading the output rules in the order specified by the play list, combining the one or more resources according to respective one of the output rules and output combined resources for the respective one of the output rules.
